(19) United States
(12) Patent Application Publication
(10) Pub. No.: US 2024/0393708 A1
(43) Pub. Date: Nov. 28, 2024

(54) TWO-COMPONENT DEVELOPER AND IMAGE FORMING APPARATUS

(71) Applicant: KYOCERA Document Solutions Inc., Osaka (JP)

(72) Inventor: Toru TAKATSUNA, Osaka-shi (JP)

(73) Assignee: KYOCERA Document Solutions Inc., Osaka (JP)

(21) Appl. No.: 18/670,407

(22) Filed: May 21, 2024

(30) Foreign Application Priority Data
May 22, 2023 (JP) 2023-083926

(51) Int. Cl. G03G 9/113; G03G 5/06; G03G 9/08; G03G 15/02

(52) U.S. Cl. CPC G03G 9/1136; G03G 5/06; G03G 9/0815; G03G 9/0819; G03G 9/0821; G03G 15/0216; G03G 2215/0607

(57) ABSTRACT

A two-component developer includes a carrier containing carrier particles and a toner containing toner particles. The carrier particles include carrier cores and coat layers covering the surfaces of the carrier cores. The coat layers contain silicone resin. The carrier particles have surfaces with a static friction coefficient of at least 0.10 and no greater than 0.22. The toner particles include toner mother particles and an external additive attached to the surfaces of the toner mother particles. The external additive includes resin particles. The resin particles have a number average primary particle diameter of at least 35 nm and no greater than 160 nm. The resin particles have a blocking rate of at least 17% by mass and no greater than 42% by mass, as measured using a mesh sieve with an opening of 75 μm after 5-minite pressure application at a temperature of 160° C. and a pressure of 0.1 kgf/mm².

### INCORPORATION BY REFERENCE

The present application claims priority under 35 U.S.C. § 119 to Japanese Patent Application No. 2023-083926, filed on May 22, 2023. The contents of this application are incorporated herein by reference in their entirety.

### BACKGROUND

The present disclosure relates to a two-component developer and an image forming apparatus.

Electrophotography uses a two-component developer includes a carrier including carrier particles and a toner including toner particles, for example. The two-component developer is required to form images with desired image density and inhibit occurrence of fogging regardless of the environment.

To meet these requirements, use of a carrier that contains carrier particles each including a carrier core and a coat layer covering the surface of the carrier core is examined as the carrier of the two-component developer. The coat layers contain a coating resin (e.g., fluororesin or silicone resin), for example. When silicone resin is used as the coating resin in the carrier (silicone resin carrier), the coat layers have high durability and other components (e.g., an external additive contained in a toner) hardly attach to the surfaces of the carrier particles. As such, use of the silicone resin carrier as the carrier of the two-component developer can impart charge stability and fluidity to the toner to some extent. As an example of the two-component developer with the silicone resin carrier, a two-component developer is proposed that includes a silicone resin carrier and a non-magnetic toner containing non-magnetic colored resin particles and resin fine particles.

### SUMMARY

A two-component developer according to a first embodiment of the present disclosure includes a carrier containing carrier particles and a toner containing toner particles. The carrier particles each include a carrier core and a coat layer covering a surface of the carrier core. The coat layers contain a silicone resin. The carrier particles have surfaces with a static friction coefficient of at least 0.10 and no greater than 0.22. The toner particles each include a toner mother particle and an external additive attached to a surface of the toner mother particle. The external additive includes resin particles. The resin particles have a number average primary particle diameter of at least 35 nm and no greater than 160 nm. The resin particles have a blocking rate of at least 17% by mass and no greater than 42% by mass, as measured using a mesh sieve with an opening of 75 μm after 5-minite pressure application at a temperature of 160° C. and a pressure of 0.1 kgf/mm².

An image forming apparatus according to a second embodiment of the present disclosure includes the aforementioned two-component developer, an image bearing member, a charger that charges a surface of the image bearing member, a light exposure device that exposes the charged surface of the image bearing member to light to form an electrostatic latent image on the surface of the image bearing member, and a development device that develops the electrostatic latent image into a toner image by supplying the toner to the surface of the image bearing member. The image bearing member is an organic photoconductor.

### BRIEF DESCRIPTION OF THE DRAWINGS

FIG. 1 is a diagram illustrating an example of a carrier particle included in a two-component developer according to a first embodiment of the present disclosure.

FIG. 2 is a diagram illustrating an example of a toner particle included in the two-component developer according to the first embodiment.

FIG. 3 is a diagram illustrating an example of an image forming apparatus according to a second embodiment of the present disclosure.

### DETAILED DESCRIPTION

The following describes preferred embodiments of the present disclosure. Note that a carrier is a collection (e.g., a powder) of carrier particles. A toner is a collection (e.g., a powder) of toner particles. An external additive is a collection (e.g., a powder) of external additive particles. Unless otherwise stated, evaluation results (values indicating shape or physical properties) for a powder (specific examples include a powder of toner particles, a powder of external additive particles, a magnetic powder, and a powder of carrier particles) are number averages of values as measured for a suitable number of particles selected from the powder.

The volume median diameter (D₅₀) of a powder is a value as measured using a laser diffraction/scattering type particle size distribution analyzer (e.g., “LA-920V2” produced by HORIBA, Ltd. or “COULTER COUNTER MULTISIZER 3” produced by Beckman Coulter, Inc.) unless otherwise stated.

Unless otherwise stated, the number average primary particle diameter of a powder is a number average value of equivalent circle diameters of primary particles (Heywood diameters: diameters of circles having the same areas as projected areas of the primary particles) of the powder as measured using a scanning electron microscope. The number average primary particle diameter of a powder is a number average value of equivalent circle diameters of 100 primary particles of the powder, for example. The number average primary particle diameter of particles refers to a number average primary particle diameter of the particles of a powder unless otherwise stated.

Chargeability means chargeability in triboelectric charging unless otherwise stated. For example, a measurement target (e.g., a toner) is triboelectrically charged by mixing and stirring the measurement target with a standard carrier (standard carrier for use with negatively chargeable toner: N-01, standard carrier for use with positively chargeable toner: P-01) provided by The Imaging Society of Japan. The amount of charge of the measurement target is measured using for example a compact suction-type charge measuring device (e.g., “MODEL 212HS”, product of TREK, INC.) before and after triboelectric charging. A larger change in amount of charge between before and after triboelectric charging indicates stronger chargeability of the measurement target.

The “main component” of a material means a component most abundant in the material in terms of mass unless otherwise stated.

In the following description, the term “-based” may be appended to the name of a chemical compound to form a generic name encompassing both the chemical compound itself and derivatives thereof. Also, when the term “-based” is appended to the name of a chemical compound used in the name of a polymer, the term indicates that a repeating unit of the polymer originates from the chemical compound or a derivative thereof. The term “(meth) acryl” is used as a generic term for both acryl and methacryl. One type of each component described in the present specification may be used independently, or two or more types of the component may be used in combination.

### First Embodiment: Two-Component Developer

A first embodiment of the present disclosure relates to a two-component developer. The two-component developer of the present embodiment includes a carrier containing carrier particles and a toner containing toner particles. The carrier particles each include a carrier core and a coat layer covering the surface of the carrier core. The coat layers contain a silicone resin. The carrier particles have surfaces with a static friction coefficient of at least 0.10 and no greater than 0.22. The toner particles each include a toner mother particle and an external additive attached to the surface of the toner mother particle. The external additive includes resin particles. The resin particles have a number average primary particle diameter of at least 35 nm and no greater than 160 nm. The resin particles have a blocking rate of at least 17% by mass and no greater than 42% by mass, as measured using a mesh sieve with an opening of 75 μm after 5-minite pressure application at a temperature of 160° C. and a pressure of 0.1 kgf/mm².

The two-component developer of the present embodiment can be used for image formation by electrophotographic apparatuses (image forming apparatuses), for example. When the carrier and the toner of the two-component developer of the present embodiment are stirred in a development device, the toner is charged.

The two-component developer of the present embodiment can be obtained by mixing while stirring the carrier and the toner using a mixier (specific examples include a ball mill and a ROCKING MIXER (registered Japanese trademark), for example. The toner has a percentage content (toner concentration) of preferably at least 1% by mass and no greater than 20% by mass in the two-component developer of the present embodiment, and more preferably at least 4% by mass and no greater than 10% by mass.

As a result of having the above features, the two-component developer of the present embodiment can form images with desired image density and inhibit occurrence of fogging regardless of the environment. The reasons therefor are inferred as follows. The toner particles included in the two-component developer of the present embodiment include resin particles as an external additive. The resin particles functions as spacer particles to inhibit state change of the surfaces of the toner particles upon contact of the toner particles with other components (e.g., the other toner particles and the carrier particles). Thus, the resin particles inhibit change in chargeability of the toner particles in image formation. Here, the resin particles have a blocking rate, which serves as an indicator of particle hardness, of at least 17% by mass and no greater than 42% by mass. When adequate hardness is imparted to the resin particles (when the blocking rate is set to no greater than 42% by mass), the resin particles can satisfactorily function as the spacer particles. When hardness is not imparted so excessively to the resin particles (when the blocking is set to at least 17% by mass) by contrast, the surface of a photosensitive member can be inhibited from being polished. Note that when the surface of a photosensitive member is polished, the surface potential of the photosensitive member decreases, resulting in possible occurrence of fogging.

The carrier particles included in the two-component developer of the present embodiment include coat layers containing a silicone resin, which is a resin with a low friction coefficient. This results in the surfaces of the carrier particles having a static friction coefficient of at least 0.10 and no greater than 0.22. When the static friction coefficient of the surfaces of the carrier particles is relatively low (no greater than 0.22), the surface of a photosensitive member can be inhibited from being polished. When the static friction coefficient of the surfaces of the carrier particles is not excessively low (at least 0.10), the toner particles can be triboelectrically charged sufficiently. As stated above, in the two-component developer of the present embodiment, the resin particles included in the toner particles favorably function as spacer particles and the surface of a photosensitive member can be inhibited from being polished by the carrier particles and the toner particles. As a result, the two-component developer of the present embodiment can form images with desired image density and inhibit occurrence of fogging regardless of the environment.

The two-component developer of the present embodiment is particularly suitable as a two-component developer used in image forming apparatuses including an organic photoconductor (OPC). The organic photosensitive member is softer than any other photosensitive members (e.g., an amorphous silicon photosensitive member) and has a surface liable to be polished. However, the surface of even an organic photosensitive member can be inhibited from being polished by the carrier particles and the toner particles included in the two-component developer of the present embodiment because of the reasons stated above. Therefore, the two-component developer of the present embodiment can inhibit occurrence of fogging regardless of the environment even when used in image forming apparatuses including an organic photosensitive member (OPC).

### [Carrire Particles]

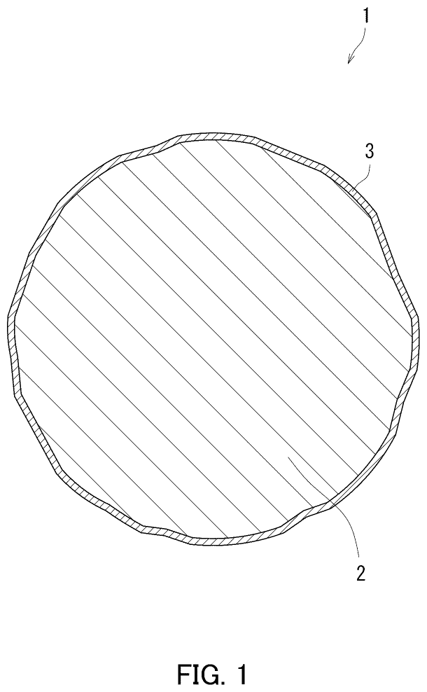

With reference to FIG. 1, an example of the carrier particles contained in the carrier is described. FIG. 1 illustrates a carrier particle 1 being an example of the carrier particles. The carrier particle 1 includes a carrier core 2 and a coat layer 3 covering the surface of the carrier core 2. The coat layer 3 contains a silicone resin. The coat layer 3 covers the entirety of the surface of the carrier core 2.

The carrier particle 1 has been described so far with reference to FIG. 1. However, the carrier particles contained in the carrier are not limited to the carrier particle 1 in FIG. 1. For example, the coat layer may cover at least a part of the carrier core. In other words, a part of the carrier core may be exposed. Alternatively or additionally, the coat layer may have a multilayered structure.

The surfaces of the carrier particles have a static friction coefficient of at least 0.10 and no greater than 0.22, and preferably at least 0.13 and no greater than 0.17. As a result of the static friction coefficient of the surfaces of the toner particles being set to at least 0.10, the carrier particles can triboelectrically charge the toner particles sufficiently. As such, the two-component developer of the present embodiment can form images with desired image density regardless of the environment. As a result of the static friction coefficient of the surfaces of the carrier particles being set to no greater than 0.22, the surface of a photosensitive member can be inhibited from being polished by the carrier particles. As such, the two-component developer of the present embodiment can inhibit occurrence of fogging regardless of the environment. Note that the static friction coefficient of the surfaces of the carrier particles is measured at a temperature of 25° C. by the method described in Examples or a method in accordance therewith.

The static friction coefficient of the surfaces of the carrier particles can be adjusted within the range described above for example by adding a resin with a low friction coefficient (e.g., a silicone resin) to the coat layers or by increasing the heating temperature in coat layer formation to increase the hardness of the coat layers.

### (Carrier Cores)

The carrier cores preferably contain a magnetic material. The carrier cores may be particles of a magnetic material or particles (also referred to below as resin carrier cores) containing a binder resin and particles of a magnetic material dispersed in the binder resin.

Examples of the magnetic material contained in the carrier cores include ferromagnetic metals (specific examples include iron, cobalt, nickel, and alloys containing at least one of the metals) and oxides of ferromagnetic metals. Examples of the oxides of ferromagnetic metals include ferrites and magnetite which is a spinel ferrite. Examples of the ferrites include Ba ferrite, Mn ferrite, Mn—Zn ferrite, Ni—Zn ferrite, Mn—Mg ferrite, Ca—Mg ferrite, Li ferrite, Cu—Zn ferrite, and Mn—Mg—Sr ferrite. The carrier cores may be produced by pulverizing and baking the magnetic material, for example. The saturation magnetization of the carrier can be adjusted by changing the amount of the magnetic material added (particularly, the amount of the ferromagnetic material added) in production of the carrier cores. The roundness of the carrier cores can be adjusted by changing the baking temperature in production of the carrier cores. A commercially available product may be used as the carrier cores.

The particles of the magnetic material used as the carrier cores may be ferrite particles, for example. Ferrite particles tend to exhibit sufficient magnetic properties for image formation using a two-component developer. Ferrite particles produced by a typical production method tend to have a shape that is not truly spherical, with appropriate projections and recesses on the surfaces thereof. When the carrier cores are ferrite particles (ferrite cores), the arithmetic mean roughness (specifically, arithmetic mean roughness Ra defined in the Japanese Industrial Standards (JIS) B0601-2013) of the surfaces of the ferrite cores is preferably at least 0.3 μm and no greater than 2.0 μm in terms of increasing adhesion between the surfaces of the ferrite cores and the coat layers.

The binder resin in the resin carrier cores is preferably polyester resin, urethane resin, or phenolic resin, and more preferably phenolic resin. The particles of the magnetic material in the resin carrier cores may be particles containing at least one of the magnetic materials listed as the examples of the magnetic material, for example.

The carrier cores have a percentage content of preferably at least 80% by mass and no greater than 99% by mass to the total mass of the carrier cores and the coat layers in the carrier particles, and more preferably at least 95% by mass and no greater than 99% by mass.

The carrier cores preferably have a number average primary particle diameter of at least 20 μm and no greater than 60 μm. As a result of the number average primary particle diameter of the carrier cores being set to at least 20 μm, the two-component developer of the present embodiment can inhibit occurrence of carrier development. As a result of the number average primary particle diameter of the carrier cores being set to no greater than 60 μm, the two-component developer of the present embodiment can have optimized developability.

The carrier cores have a saturation magnetization of preferably at least 60 emu/g and no greater than 80 emu/g in an applied magnetic field of 3000 Oe. As a result of the saturation magnetization of the carrier cores being set to at least 60 emu/g, the two-component developer of the present embodiment can inhibit occurrence of carrier development. As a result of the saturation magnetization of the carrier cores being set to no greater than 80 emu/g, the two-component developer of the present embodiment can have optimized developability.

### (Coat Layers)

The coat layers contain a silicone resin. The coat layers have a thickness of at least 0.3 μm and no greater than 2.0 μm, for example.

The coat layers have a mass of preferably at least 0.5 parts by mass and no greater than 10.0 parts by mass relative to 100 parts by mass of the carrier cores, and more preferably at least 1.0 part by mass and no greater than 3.0 parts by mass. As a result of the mass of the coat layers being set to at least 0.5 parts by mass, exposure of the carrier cores can be inhibited. As a result of the mass of the coat layers being set to no greater than 5.0 parts by mass, toner charging by the carrier can be facilitated.

### (Silicone Resin)

The silicone resin is a resin with a polysiloxane structure (e.g., alkyl polysiloxane structure). Examples of the silicone resin include epoxy resin modified silicone resins and silicone resins with a methyl group. Examples of the silicone resins with a methyl group include a silicone resin (also referred to below as “methyl silicone resin”) with a methyl group and without a phenyl group and a silicone resin (methylphenyl silicone resin) with a methyl group and a phenyl group. The silicone resin is preferably a methyl silicone resin.

The coat layers preferably contain only the silicone resin, but may further contain an optional component as long as it is in a small amount. Examples of the optional component include resins other than the silicone resin, inorganic particles (e.g., metal oxide particles and carbon black particles), a charge control agent, an adhesion improver, and a crosslinking agent. The silicone resin has a percentage content of preferably at least 90% by mass in the coat layers, and more preferably 100% by mass.

### (Carrier Production Method)

One example of a carrier production method is described. The carrier production method includes an application process of applying a coating liquid onto the surfaces of carrier cores and a heating process of heating the carrier cores after the application process.

### (Application Process)

In the present process, a coating liquid is applied onto the surfaces of carrier cores. The coating liquid contains a silicone resin and a solvent. The silicone resin may be a thermosetting silicone resin. The coating liquid preferably has a solid concentration of at least 10% by mass and no greater than 30% by mass.

Examples of the solvent of the coating liquid include lactam compounds (e.g., 2-pyrrolidone and N-methyl-2-pyrrolidone), ketone compounds (e.g., methyl ethyl ketone and methyl isobutyl ketone), cyclic ether compounds (e.g., tetrahydrofuran and tetrahydropyran), alcohol compounds (e.g., normal butanol and isobutanol), ester solvents (e.g., ethyl acetate and isobutyl acetate), and aromatic hydrocarbon compounds (e.g., toluene and xylene). The solvent of the coating liquid is preferably toluene.

Examples of the method for applying the coating liquid onto the surfaces of the carrier cores include immersion of the carrier cores in the coating liquid and spraying the coating liquid to the carrier cores in a fluidized bed. In the immersion of the carrier cores in the coating liquid, a small amount of the coating liquid is applied onto the projections of the surfaces of the carrier cores while a large amount of the coating liquid is applied onto the recesses thereof, leading to non-uniform application of the coating liquid. In the spraying of the coating liquid to the carrier cores in a fluidized bed by contrast, uniform application of the coating liquid to both the projections and the recesses of the surfaces of the carrier cores tend to be achieved. Therefore, the coating liquid is applied onto the surfaces of the carrier cores preferably by spraying the coating liquid to the carrier cores in a fluidized bed.

### (Heating Process)

In the present process, the carrier cores after the application process are heated to remove the solvent contained in the coating liquid. When the coating liquid contains uncured silicone resin, the uncured silicone resin is also thermally cured. Thus, the coat layers are formed with the coating liquid. The heating temperature in the heating process is preferably at least 260° C. and no greater than 390° C., and more preferably at least 300° C. and no greater than 350° C. The heating time in the heating process is preferably at least 30 minutes and no greater than 90 minutes, and more preferably at least 50 minutes and no greater than 70 minutes.

### [Toner]

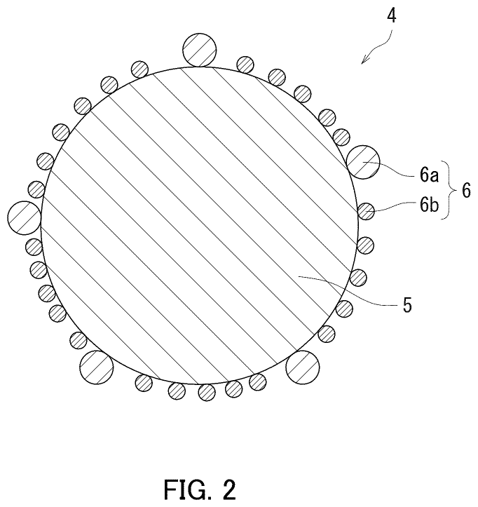

The toner contains toner particles. The toner particles each include a toner mother particle and an external additive attached to the surface of the toner mother particle. The external additive includes resin particles. The toner are described in detail below with reference to FIG. 2 as appropriate.

FIG. 2 illustrates an example of a toner particle 4 contained in the toner. The toner particle 4 illustrated in FIG. 2 includes a toner mother particle 5 and an external additive 6 attached to the surface of the toner mother particle 5. The external additive 6 includes resin particles 6a and silica particles 6b.

The toner particles have been descried so far with reference to FIG. 2. However, the toner particles may have a structure different from that of the toner particle 4 illustrated in FIG. 2. Specifically, the external additive may include only the resin particles. Alternatively, the external additive may include additional external additive particles other than the resin particles and the silica particles. The toner mother particles may be capsule toner particles each including a toner core and a shell layer covering the toner core.

### (External Additive)

The external additive is attached to the surfaces of the toner mother particles. The external additive includes resin particles. Preferably, the external additive further includes silica particles. The external additive may include additional particles other than the resin particles and the silica particles, but preferably include only the resin particles and the silica particles. The total percentage content of the resin particles and the silica particles is preferably at least 90% by mass in the external additive, more preferably at least 99% by mass, and further preferably 100% by mass.

### (Resin Particles)

The resin particles are particles containing a resin as a main component. The resin particles have a blocking rate of at least 17% by mass and no greater than 42% by mass, as measured using a mesh sieve with an opening of 75 μm after 5-minite pressure application at a temperature of 160° C. and a pressure of 0.1 kgf/mm², more preferably at least 25% by mass and no greater than 42% by mass, and further preferably at least 35% by mass and no greater than 42% by mass. The blocking rate of the resin particles serves as an indicator of hardness of the resin particles. The harder the resin particles, the lower blocking rate of the resin particles. As a result of the blocking rate of the resin particles being set to at least 17% by mass, the surface of a photosensitive member can be inhibited from being polished by the toner particles. Thus, the two-component developer of the present embodiment can inhibit occurrence of fogging regardless of the environment. As a result of the blocking rate of the resin particles being set to no greater than 42% by mass, the resin particles can easily function as spacer particles. Thus, the two-component developer of the present embodiment can form images with desired image density regardless of the environment.

The resin contained in the resin particles is preferably styrene-(meth)acrylic resin. The percentage content of the styrene-(meth)acrylic resin is preferably at least 70% by mass in the resin particles, more preferably at least 95% by mass, and further preferably 100% by mass.

Styrene-(meth)acrylic resin is a copolymer of a styrene compound and a (meth)acrylic acid compound. Examples of the (meth)acrylic acid compound include (meth)acrylic acids, (meth)acrylonitriles, and (meth)acrylic acid alkyl esters (especially, a (meth)acrylic acid alkyl ester with an alkyl group having a carbon number of at least 1 and no greater than 4 in its ester moiety).

The styrene-(meth)acrylic resin preferably includes a first repeating unit derived from a styrene compound and a second repeating unit derived from a (meth)acrylic acid alkyl ester.

Examples of the styrene compound include styrene, alkyl styrenes (specific examples include α-methylstyrene, o-methylstyrene, m-methylstyrene, p-methylstyrene, ethylstyrene, 2,3-dimethylstyrene, 2,4-dimethylstyrene, o-tert-butylstyrene, m-tert-butylstyrene, and p-tert-butylstyrene), and halogenated styrenes (specific examples include α-chlorostyrene, o-chlorostyrene, m-chlorostyrene, and p-chlorostyrene). The styrene compound is preferably styrene.

The first repeating unit has a percentage content of preferably at least 5.0% by mass and no greater than 30.0% by mass to all repeating units included in the styrene-(meth)acrylic resin, more preferably at least 10.0% by mass and no greater than 14.0% by mass, and further preferably at least 12.0% by mass and no greater than 13.5% by mass.

Examples of the (meth)acrylic acid alkyl ester include methyl (meth)acrylate, ethyl (meth)acrylate, n-propyl (meth)acrylate, iso-propyl (meth) acrylate, butyl (meth)acrylate (in detail, n-butyl (meth)acrylate), iso-butyl (meth) acrylate, and 2-ethylhexyl (meth)acrylate. The (meth)acrylic acid alkyl ester is preferably butyl (meth)acrylate.

The second repeating unit has a percentage content of preferably at least 40.0% by mass and no greater than 80.0% by mass to all the repeating units included in the styrene-(meth)acrylic resin, more preferably at least 50.0% by mass and no greater than 70.0% by mass, and further preferably at least 60.0% by mass and no greater than 65.0% by mass.

Preferably, the styrene-(meth)acrylic resin further includes a third repeating unit derived from a crosslinking agent. That is, it is preferable that the styrene-(meth)acrylic resin is a crosslinked styrene-(meth)acrylic resin including the first repeating unit derived from a styrene compound, the second repeating unit derived from a (meth)acrylic acid alkyl ester, and the third repeating unit derived from a crosslinking agent. As a result of the resin particles containing such a crosslinked styrene-(meth)acrylic resin, adequate rigidity is imparted to the resin particles to allow the resin particles to easily function as spacer particles.

An example of the crosslinking agent is a compound with two or more vinyl groups. Specific examples of the crosslinking agent include N,N′-methylenebisacrylamide, divinylbenzene, ethylene glycol diacrylate, ethylene glycol dimethacrylate, diethylene glycol diacrylate, tetraethylene glycol diacrylate, polyethylene glycol diacrylate, 1,4-butanediol diacrylate, 1,6-hexanediol diacrylate, tripropylene glycol diacrylate, trimethylolpropane triacrylate, pentaerythritol triacrylate, pentaerythritol tetraacrylate, 1,4-butanediol dimethacrylate, and 1,6-hexanediol dimethacrylate. The crosslinking agent is preferably divinylbenzene.

The third repeating unit has a percentage content of preferably at least 20.0% by mass and no greater than 40.0% by mass to all the repeating units included in the styrene-(meth)acrylic resin, more preferably at least 20.0% by mass and no greater than 32.0% by mass, and further preferably at least 20.0% by mass and no greater than 25.0% by mass. As a result of the percentage content of the third repeating unit being set to at least 20.0% by mass, adequate rigidity can be imparted to the resin particles to allow the resin particles to further easily function as spacer particles. As a result of the percentage content of the third repeating unit being set to no greater than 40.0% by mass, rigidity of the resin particles is not excessively increased to effectively inhibit the surface of a photosensitive member from being polished.

The crosslinked resin preferably includes a repeating unit derived from styrene, a repeating unit derived from butyl methacrylate, and a repeating unit derived from divinylbenzene.

The resin particles have a number average primary particle diameter of at least 35 nm and no greater than 160 nm, preferably at least 50 nm and no greater than 100 nm, and more preferably at least 60 nm and no greater than 80 nm. As a result of the number average primary particle diameter of the resin particles being set to at least 35 nm, the resin particles can be inhibited from being buried in the toner mother particles. As a result of the number average primary particle diameter of the resin particles being set to no greater than 160 nm, the resin particles can be inhibited from separating from the toner mother particles.

In terms of allowing the resin particles to sufficiently exhibiting their function while inhibiting separation of the resin particles from the toner mother particles, the resin particles have a content of preferably at least 0.1 parts by mass and no greater than 5.0 parts by mass relative to 100 parts by mass of the toner mother particles in the toner particles, more preferably at least 0.2 parts by mass and no greater than 1.5 parts by mass, and further preferably at least 0.4 parts by mass and no greater than 0.8 parts by mass. As a result of the content of the resin particles being set to at least 0.1 parts by mass, the resin particles can sufficiently function as spacer particles. As a result of the content of the resin particles being set to no greater than 5.0 parts by mass, the resin particles can be inhibited from separating from the toner mother particles.

The resin particles can be produced by emulsion polymerization of monomers (e.g., a styrene compound, a (meth)acrylic acid compound, and a crosslinking agent) being raw materials in presence of an ionic surfactant (emulsifier). Benzoyl peroxide can be used as a polymerization initiator for emulsion polymerization, for example. The amount of the ionic surfactant used is at least 2 parts by mass and no greater than 7 parts by mass relative to 100 parts by mass of the monomers being the raw materials. The amount of the polymerization initiator used is at least 5 parts by mass and no greater than 15 parts by mass relative to 100 parts by mass of the monomers being the raw materials.

### (Ionic Surfactant)

Preferably, the toner particles further contain an ionic surfactant attached to the surfaces of the resin particles. The ionic surfactant is derived from the ionic surfactant used in production of the resin particles. The ionic surfactant adjusts chargeability of the toner particles. Examples of the ionic surfactant include a cationic surfactant and an anionic surfactant. The ionic surfactant is preferably a cationic surfactant.

Examples of the cationic surfactant includes alkyl trimethyl ammonium salts with an alkyl group having a carbon number of at least 10 and no greater than 25. Specifically, cetyltrimethylammonium salt is preferable as the cationic surfactant, and cetyltrimethylammonium chloride is more preferable.

Examples of the anionic surfactant includes alkyl benzene sulfonates with an alkyl group having a carbon number of at least 10 and no greater than 25. Specifically, dodecylbenzene sulfonate is preferable as the anionic surfactant, and sodium dodecylbenzenesulfonate is more preferable.

### (Silica Particles)

Preferably, the silica particles are silica particles subjected to surface treatment for imparting hydrophobicity. The silica particles have a number average primary particle diameter of preferably at least 20 nm and no greater than 100 nm, and more preferably at least 20 nm and no greater than 35 nm. As a result of the number average primary particle diameter of the silica particles being set to at least 20 nm, the silica particles can be inhibited from being buried in the toner mother particles. As a result of the number average primary particle diameter of the silica particles being set to no greater than 100 nm, the silica particles can be inhibited from separating from the toner mother particles.

In terms of allowing the silica particles to sufficiently exhibit their function while inhibiting the silica particles from separating from the toner mother particles, the content of the silica particles is preferably at least 0.1 parts by mass and no greater than 10.0 parts by mass relative to 100 parts by mass of the toner mother particles in the toner particles, and more preferably at least 0.4 parts by mass and no greater than 2.5 parts by mass.

### (Toner Mother Particles)

The toner mother particles contain at least one selected from the group consisting of a binder resin, a colorant, a charge control agent, and a releasing agent, for example. The following describes the binder resin, the colorant, the charge control agent, and the releasing agent.

### (Binder Resin)

In order to that the toners has excellent low-temperature fixability, the toner mother particles preferably contain a thermoplastic resin as the binder resin, and more preferably contain a thermoplastic resin in a percentage content of at least 85% by mass in the total of the binder resin. Examples of the thermoplastic resin include polyester resins, styrene-based resins, acrylic acid ester-based resins (specific examples include acrylic acid ester polymers and methacrylic acid ester polymers), olefin-based resins (specific examples include polyethylene resin and polypropylene resin), vinyl resins (specific examples include vinyl chloride resin, polyvinyl alcohol, vinyl ether resin, and N-vinyl resin), polyamide resins, and urethane resins. Alternatively, any of copolymers of these resins, that is, copolymers (specific examples include styrene-acrylic resin and styrene-butadiene-based resin) in which any repeating unit has been introduced into any of the resins can be used as the binder resin.

The binder resin is preferably a polyester resin. The polyester resin is a polymer of at least one polyhydric alcohol monomer and at least one polybasic carboxylic acid monomer. A polybasic carboxylic acid derivative (specific examples include anhydrides of polybasic carboxylic acids and halides of polybasic carboxylic acids) may be used instead of the polybasic carboxylic acid monomer.

Examples of the polyhydric alcohol monomer include diol monomers, bisphenol monomers, and tri- or higher-hydric alcohol monomers.

Examples of the diol monomers include ethylene glycol, diethylene glycol, triethylene glycol, 1,2-propanediol, 1,3-propanediol, 1,4-butanediol, neopentyl glycol, 2-butene-1,4-diol, 1,5-pentanediol, 1,6-hexanediol, 1,4-cyclohexanedimethanol, 1,4-benzenediol, dipropylene glycol, polyethylene glycol, polypropylene glycol, and polytetramethylene glycol.

Examples of the bisphenol monomers include bisphenol A, hydrogenated bisphenol A, bisphenol A-ethylene oxide adduct, and bisphenol A-propylene oxide adduct.

Examples of the tri- or higher-hydric alcohol monomers include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane, and 1,3,5-trihydroxymethylbenzene.

Examples of the polybasic carboxylic acid monomer include dibasic carboxylic acid monomers and tri- or higher-basic carboxylic acid monomers.

Examples of the dibasic carboxylic acid monomers include maleic acid, fumaric acid, citraconic acid, itaconic acid, glutaconic acid, phthalic acid, isophthalic acid, terephthalic acid, 5-sulfoisophthalic acid, sodium 5-sulfoisophthalate, cyclohexanedicarboxylic acid, adipic acid, sebacic acid, azelaic acid, malonic acid, succinic acid, alkyl succinic acids, and alkenyl succinic acids. Examples of the alkyl succinic acids include n-butylsuccinic acid, isobutylsuccinic acid, n-octylsuccinic acid, n-dodecylsuccinic acid, and isododecylsuccinic acid. Examples of the alkenyl succinic acids include n-butenylsuccinic acid, isobutenylsuccinic acid, n-octenylsuccinic acid, n-dodecenylsuccinic acid, and isododecenylsuccinic acid.

Examples of the tri- or higher-basic carboxylic acid monomers include 1,2,4-benzenetricarboxylic acid (trimellitic acid), 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl) methane, 1,2,7,8-octanetetracarboxylic acid, pyromellitic acid, and Empol trimer acid.

The polyester resin is preferably a polymer of a bisphenol monomer, a dibasic carboxylic acid monomer, and a tribasic carboxylic acid monomer, and more preferably a polymer of bisphenol A-alkylene oxide adduct, terephthalic acid, isophthalic acid, and trimellitic acid.

The polyester resin is preferably non-crystalline. For non-crystalline polyester resins, it is often not possible to measure a clear melting point. Therefore, a polyester resin for which no clear endothermic peak can be identified in an endothermic curve plotted using a differential scanning calorimeter can be considered a non-crystalline polyester resin.

### (Colorant)

The colorant may be a known pigment or dye that matches the color of the toner. Examples of the colorant include a black colorant, a yellow colorant, a magenta colorant, and a cyan colorant.

The black colorant may be carbon black, for example. Alternatively, the black colorant may be a colorant whose color is adjusted to a black color using a yellow colorant, a magenta colorant, and a cyan colorant.

The colorant has a content of at least 1 part by mass and no greater than 20 parts by mass relative to 100 parts by mass of the binder resin in the toner.

### (Charge Control Agent)

The charge control agent is used for the purpose of obtaining a toner excellent in charge stability and charge rise characteristics, for example. The charge rise characteristics of the toner serve as an indicator as to whether the toner can be charged to a specific charge level in a short period of time. Examples of the charge control agent include a positively chargeable charge control agent and a negatively chargeable charge control agent. Cationic nature (positive chargeability) of the toner can be enhanced by the toner mother particles containing a positively chargeable charge control agent. Anionic nature of the toner can be enhanced by the toner mother particles containing a negatively chargeable charge control agent. Examples of the positively chargeable charge control agent include pyridine, nigrosine, and quaternary ammonium salts. Examples of the negatively chargeable charge control agent include metal-containing azo dyes, sulfo group-containing resins, oil-soluble dyes, naphthenic acid metal salts, acetylacetone metal complexes, salicylic acid-based metal complexes, boron compounds, fatty acid soaps, and long-chain alkyl carboxylates. However, the toner mother particles need not contain a charge control agent when sufficient chargeability is ensured in the toner. The charge control agent has a content of at least 0.1 parts by mass and no greater than 5 parts by mass relative to 100 parts by mass of the binder resin in the toner mother particles, and more preferably at least 0.4 parts by mass and no greater than 2.5 parts by mass.

### (Releasing Agent)

The releasing agent is used for the purpose of obtaining toners excellent in hot offset resistance, for example. Examples of the releasing agent include aliphatic hydrocarbon-based waxes, oxides of aliphatic hydrocarbon-based waxes, plant waxes, animal waxes, mineral waxes, ester waxes having a fatty acid ester as a main component, and waxes in which a fatty acid ester has been partially or fully deoxidized. Examples of the aliphatic hydrocarbon-based waxes include polyethylene waxes (e.g., low molecular weight polyethylene), polypropylene waxes (e.g., low molecular weight polypropylene), polyolefin copolymers, polyolefin wax, microcrystalline wax, paraffin wax, and Fischer-Tropsch wax. Examples of the oxides of aliphatic hydrocarbon-based waxes include oxidized polyethylene wax and block copolymers of oxidized polyethylene wax. Examples of the plant waxes include candelilla wax, carnauba wax, Japan wax, jojoba wax, and rice wax. Examples of the animal waxes include beeswax, lanolin, and spermaceti. Examples of the mineral waxes include ozokerite, ceresin, and petrolatum. Examples of the ester waxes having a fatty acid ester as a main component include montanic acid ester wax and castor wax. Examples of the waxes in which a fatty acid ester has been partially or fully deoxidized include deoxidized carnauba wax. The content of the releasing agent is preferably at least 1 part by mass and no greater than 20 parts by mass relative to 100 parts by mass of the binder resin in the toner mother particles, and more preferably at least 3 parts by mass and no greater than 10 parts by mass.

The toner particles may contain a known additive as necessary. Preferably, the toner particles have a volume median diameter of at least 4 μm and no greater than 12 μm. The toner mother particles have a volume median diameter of preferably at least 4 μm and no greater than 12 μm, and more preferably at least 5 μm and no greater than 9 μm. The toner particles may be magnetic particles or non-magnetic particles. When the toner particles are magnetic particles, the toner mother particles further contain a magnetic powder.

### (Toner Production Method)

One example of a method for producing the toner contained in the tow-component developer of the present embodiment is described below. The toner production method includes a toner mother particle preparation process of preparing the toner mother particles and an external additive addition process of attaching the external additive to the surfaces of the toner mother particles. The external additive includes resin particles.

### (Toner Mother Particle Preparation Process)

In the toner mother particle preparation process, the toner mother particles are prepared by the pulverization method or the aggregation method, for example. In the toner mother particle preparation process, the toner mother particles are preferably prepared by the pulverization method. In other words, the toner mother particles in the toner are preferably pulverized toner mother particles.

In one example of the pulverization method, the binder resin and any other components added as necessary are mixed first. Subsequently, the resulting mixture is melt-kneaded using a melt-kneader (e.g., a single or twin screw extruder). Subsequently, the resulting melt-kneaded product is pulverized and classified. Thus, the toner mother particles are obtained.

One example of the aggregation method is described next. In an aqueous medium containing fine particles of each of the binding resin and the other components added as necessary, these fine particles are aggregated until they reach the desired particle diameter. This forms aggregated particles containing the binder resin and the like. Subsequently, the resulting aggregated particles are heated to coalesce the components contained in the aggregated particles. Thus, the toner mother particles are obtained.

### (External Additive Addition Process)

In the present process, the external additive is attached to the surfaces of the toner mother particles. One example of a method for attaching the external additive to the surfaces of the toner mother particles is mixing while stirring the toner mother particles and the external additive particles using a mixer.

### Second Embodiment: Image Forming Apparatus

A second embodiment relates to an image forming apparatus. The image forming apparatus of the present embodiment includes the two-component developer described in the first embodiment, an image bearing member, a charger that charges the surface of the image bearing member, a light exposure device that exposes the charged surface of the image bearing member to light to form an electrostatic latent image on the surface of the image bearing member, and a development device that develops the electrostatic latent image into a toner image by supplying toner to the surface of the image bearing member. The image bearing member is an organic photosensitive member. Preferably, the system linear velocity of the image forming apparatus of the present embodiment is at least 250 mm/sec and no greater than 500 mm/sec.

As a result of including the two-component developer described in the first embodiment, the image forming apparatus of the present embodiment can form images with desired image density and inhibit occurrence of fogging regardless of the environment.

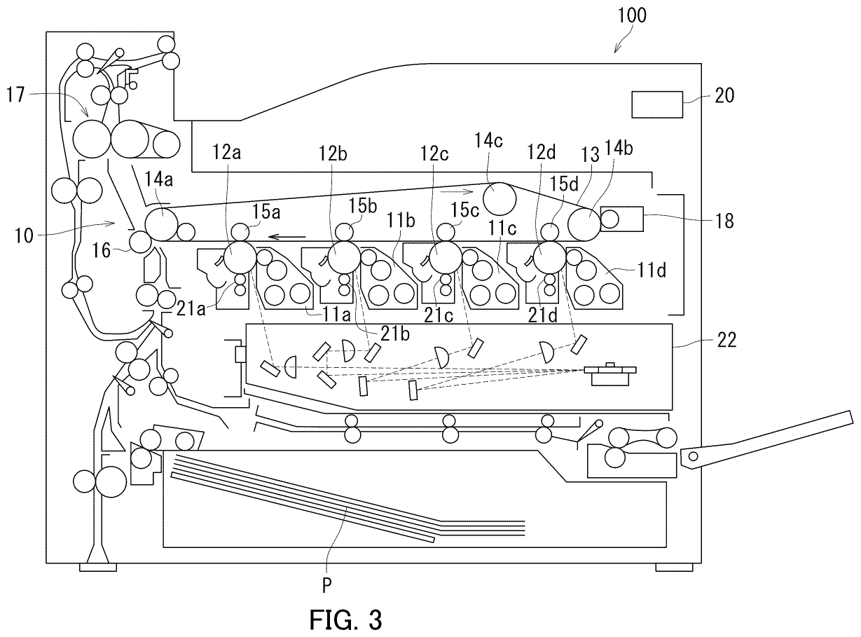

The following describes an image forming apparatus 100, which is one example of the image forming apparatus of the present embodiment, with reference to FIG. 3. The image forming apparatus 100 is a tandem electrophotographic apparatus. As illustrated in FIG. 3, the image forming apparatus 100 includes development devices 11a to 11d, photosensitive drums 12a to 12d, a transfer device 10, a fixing device 17, a cleaner 18, and chargers 21a to 21d. The transfer device 10 includes a transfer belt 13, a drive roller 14a, a driven roller 14b, a tension roller 14c, primary transfer rollers 15a to 15d, and a secondary transfer roller 16. The transfer belt 13 is wound around the drive roller 14a, the driven roller 14b, and the tension roller 14c. The transfer belt 13 is driven by the drive roller 14a to circulate in the direction indicated by the arrows in FIG. 3. The fixing device 17 is a fixing device of nip fixing type including a heating roller and a pressure roller, for example. The cleaner 18 removes toner remaining on the transfer belt 13. In order to form images using the image forming apparatus 100, the two-component developer of the first embodiment is loaded in the development devices 11a to 11d. The image forming apparatus 100 includes a controller 20 that electronically controls operation of the image forming apparatus 100 based on outputs from various sensors. The controller 20 includes a central processing unit (CPU), random access memory (RAM), and a storage device that stores programs therein and that stores specific data in a rewritable manner. A user is allowed to provide instructions (electric signals) to the controller 20 through a non-illustrated input unit (e.g., a keyboard, a mouse, or a touch panel).

The image forming apparatus 100 forms an electrostatic latent image on a surface layer portion (photosensitive layer) of each of the photosensitive drums 12a to 12d based on image data. Next, the formed electrostatic latent images are developed with the two-component developer (toner and carrier) loaded in the development devices 11a to 11d. The chargers 21a to 21d each electrostatically charge the photosensitive layer of a corresponding one of the photosensitive drums 12a to 12d uniformly. When there is no need to distinguish (when describing, for example, common characteristics or the like) in the following, the development devices 11a to 11d may each be referred to as a development device 11, the photosensitive drums 12a to 12d may each be referred to as a photosensitive drum 12, and the chargers 21a to 21d may each be referred to as a charger 21.

The chargers 21 are chargeable members that come in contact with the surfaces of the photosensitive drums 12 and charge the photosensitive layers by contact charging. The photosensitive layers are charged by the chargers 21 (e.g., members charged by application of direct current voltage or AC superimposed voltage, which is alternating current voltage superimposed on direct current voltage) coming into contact with the photosensitive layers. In other words, the chargers 21a, 21b, 21c, and 21d respectively charge the surfaces of the photosensitive drums 12a, 12b, 12c, and 12d (each being an image bearing member) in the image forming apparatus 100. The chargers 21 may be pressed against the surfaces of the photosensitive drums 12 by the force of springs, for example. The image forming apparatus 100 further includes a light exposure device 22 for forming electrostatic latent images on the photosensitive layers of the photosensitive drums 12a to 12d as illustrated in FIG. 3. The light exposure device 22 includes a light emitting diode (LED) head as a light source, for example. The light exposure device 22 selectively irradiates the photosensitive layers of the photosensitive drums 12a to 12d with light emitted from the LED head based on image data, for example. Light exposure of the charged photosensitive layers by the light exposure device 22 forms electrostatic latent images on the photosensitive layers.

The development devices 11 develop the electrostatic latent images with toner. In the image forming apparatus 100 in the initial state (unused state), an accommodation section inside each development device 11 accommodates the two-component developer containing the toner (initial toner) and the carrier. However, the toner (initial toner) and the carrier may be automatically loaded into the accommodation sections of the development devices 11 by initial setting (by installation operation) when the image forming apparatus 100 is put into use.

Each of the development devices 11 is provided with a container for toner replenishment (not illustrated). The containers for toner replenishment each supply toner for replenishment use to a corresponding one of the development devices 11. The containers for toner replenishment accommodate the toner for replenishment use. The toner for replenishment use in the containers for toner replenishment is supplied to a corresponding one of the development devices 11 (specifically, the accommodation section).

The initial toner and the toner for replenishment use may be the same as or different from each other. However, the initial toner and the toner for replenishment use are preferably the same as each other in order to stably form favorable images. Note that the initial toner and the toner for replenishment use are the same as each other means that there is no substantial difference in properties between these toners such that they are interchangeable.

The photosensitive drums 12 each are an organic photoconductor (OPC) drum. Each of the photosensitive drums 12 has a columnar outer shape. The photosensitive drum 12 includes a metal cylinder (e.g., an aluminum pipe) as a core member and a single-layer photosensitive layer or a multilayer photosensitive layer (including an undercoat layer, a charge generating layer, and a charge transport layer, for example), which contains a charge generating material and a charge transport material, around the core member. In addition, a protective layer for protecting the photosensitive layer may be provided on the surface of the photosensitive layer. The photosensitive drum 12 is supported at a casing of the image forming apparatus 100, for example, in a rotatable manner and driven for example by a motor (not illustrated).

The development devices 11a, 11b, 11c, and 11d attach toners to the electrostatic latent images formed on the photosensitive drums 12a, 12b, 12c, and 12d (each being an image bearing member), respectively, to develop the electrostatic latent images into toner images in the image forming apparatus 100. After formation of the toner images on the photosensitive drums 12, the image forming apparatus 100 applies bias (voltage) to the primary transfer rollers 15a to 15d to respectively transfer (primary transfer) toner (toner images) attached to the photosensitive drums 12a to 12d to the transfer belt 13 (intermediate transfer member). The toner images on the transfer belt 13 are transferred (secondary transfer) to a printing sheet P, which is a recording medium (transfer target) being conveyed, by bias (voltage) application to the secondary transfer roller 16. Thereafter, the fixing device 17 heats the toner to fix the toner to the printing sheet P. Thus, an image is formed on the printing sheet P.

The image forming apparatus 100 includes a plurality of photosensitive drums 12a to 12d. In the above configuration, the image forming apparatus 100 sequentially transfers the toner images formed on the photosensitive drums 12a to 12d to the transfer belt 13 in primary transfer to superimpose the toner images (e.g., toner images with mutually different colors) on the transfer belt 13. The image forming apparatus 100 transfers the toner images superimposed on the transfer belt 13 to the printing sheet P in batches in secondary transfer. For example, superimposition of toner images in 4 colors of black, yellow, magenta, and cyan can form a full color image.

The image forming apparatus 100 has been described so far with reference to FIG. 3. However, the image forming apparatus of the present embodiment is not limited to the image forming apparatus 100 illustrated in FIG. 3. For example, the image forming apparatus of the present embodiment may be a monochrome image forming apparatus. The image forming apparatus may adopt the rotary system. The chargers may each be a charger (e.g., a scorotron charger, a charging brush, or a corotron charger) other than the charging roller. The image forming apparatus may not include the cleaner.

### EXAMPLES

The present disclosure is described below further specifically using examples. However, the present disclosure is not limited to the scope of the examples.

In the present examples, the saturation magnetization and the coercivity of carrier cores were measured using a high-sensitivity vibrating sample magnetometer (“VSM-P7”, product of Toei Industry Co., Ltd.) under a condition of an applied magnetic field of 3000 Oe.

The number average primary particle diameters of resin particles, silica particles, and carrier cores were measured using a scanning electron microscope (“JSM-7600F”, product of JEOL Ltd., field emission scanning electron microscope). In the number average primary particle diameter measurement, the equivalent circle diameters of 100 primary particles (Heywood diameters: diameters of circles having the same areas as projected areas of the primary particles) were measured and a number average of the equivalent circle diameters was calculated.

### [Static Friction Coefficient Measurement]

The static friction coefficients of the surfaces of carrier particles were measured at 25° C. by the following method. A carrier was placed on a planer sample plate. In doing so, the carrier was spread to uniformly cover the entire surface of the sample plate. Next, the static friction coefficient of the surface of the sample plate was measured using a potable friction meter (“MUSE TYPE: 94i-II”, product of Shinto Scientific Co., Ltd.). The measurement was performed 5 times (n=5), and the average thereof was used as a measurement value of the static friction coefficient of the surfaces of the carrier particles.

### [Polyester Resin Synthesis]

A stainless jacket tank equipped with a nitrogen inlet tube, a stirrer, two drip nozzles, a thermometer, a circulation pump, and a dehydration pipe with a mantle heater set thereto was used as a reaction vessel. The reaction vessel was charged with 500 parts by mass of terephthalic acid, 500 parts by mass of isophthalic acid, 298 parts by mass of an ethylene oxide adduct of bisphenol A (average number of moles added of ethylene oxide: 0.8 mol), and 298 parts by mass of ethylene glycol. Next, the interior of the reaction vessel was set to a nitrogen atmosphere and the internal temperature of the reaction vessel was increased up to 250° C. while stirring the contents of the reaction vessel. Next, the contents of the reaction vessel were allowed to react at 250° C. under the normal pressure (101 kPa) for 4 hours. Next, 0.35 parts by mass of antimony trioxide, 0.22 parts by mass of triphenyl phosphate, and 0.04 parts by mass of tetrabutyl titanate were further added into the reaction vessel. Next, the internal pressure of the reaction vessel was reduced to 8 kPa and the internal temperature of the reaction vessel was increased up to 280° C. Next, the contents of the reaction vessel were allowed to react at 280° C. under a pressure of 8 kPa for 6 hours. Next, the internal pressure of the reaction vessel was returned to the normal pressure (101 kPa). Next, the internal temperature of the reaction vessel was reduced to 270° C. Next, 12 parts by mass of trimellitic acid was further added into the reaction vessel. Next, the contents of the reaction vessel were allowed to react at 270° C. under the normal pressure (101 kPa) for 1 hour. After the internal temperature of the reaction vessel was reduced to the room temperature, the reaction product (polyester resin) was taken out of the reaction vessel. Thus, a polyester resin to be used as the binder resin was obtained.

### [Resin Particle Preparation]

Resin particles (P-1) to (P-7) were prepared by the following methods.

### (Resin Particles (P-1))

A 1-L four-necked flask equipped with a stirrer, a cooling tube, a thermometer, and a nitrogen inlet tube was used as a reaction vessel. Into the reaction vessel, 20 parts by mass of styrene, 100 parts by mass of n-butyl methacrylate (BMA), 35 parts by mass of divinylbenzene (DVB), 15 parts by mass of a polymerization initiator (benzoyl peroxide), 6 parts by mass of sodium dodecylbenzenesulfonate, and 600 parts by mass of ion exchange water were added under stirring of the contents of the reaction vessel.

Subsequently, a nitrogen gas was introduced into the reaction vessel under stirring of the contents of the reaction vessel to set the interior of the reaction vessel to a nitrogen atmosphere. The temperature of the contents of the reaction vessel was increased to 90° C. in the nitrogen atmosphere under stirring of the contents of the reaction vessel. Thereafter, the contents of the reaction vessel were allowed to react (specifically, polymerization reaction) for a reaction time T (3.0 hours for the resin particles (P-1)) shown below in Table 1 at a temperature of 90° C. in the nitrogen atmosphere under stirring of the contents of the reaction vessel to obtain an emulsion containing the reaction product (resin particles (P-1)). Subsequently, the resulting emulsion was cooled, washed, and dehydrated. Thus, a powder of the resin particles (P-1) with a number average primary particle diameter of 70 nm was obtained. The resin particles (P-1) contained a crosslinked resin. A surfactant (sodium dodecylbenzenesulfonate) was attached to the surfaces of the resin particles (P-1).

### (Resin Particles (P-2) to (P-7))

Resin particles (P-2) to (P-7) were prepared according to the same method as that for preparing the resin particles (P-1) in all aspects other than that the amounts of the monomers and the reaction time T were changed to those shown below in Table 1. Note that “Particle diameter” below in Table 1 refers to number average primary particle diameter.

### [Blocking Rate Measurement]

The blocking rates of the resin particles (P-1) to (P-7) were measured by the following method. The measurement results are shown below in Table 1. A device (product of KYOCERA Document Solutions Japan Inc.) including a table (material: SUS304) with a columnar hole (diameter: 10 mm. depth: 10 mm), a cylindrical indenter (diameter: 10 mm, material: SUS304) and a heater was used as a measurement jig. Note that SUS304 is an iron-chromium-nickel alloy (austenitic stainless steel) with a nickel content rate of 8% by mass and a chromium content rate of 18% by mass.

In an environment at a temperature of 23° C. and a humidity of 50% RH, 10 mg of a powder of resin particles (a powder of any of the resin particles (P-1) to (P-7)) being a measurement target was filled in the hole (measurement site) of the jig. Subsequently, the measurement site was heated to 160° C. using the heater of the jig and 0.1 kgf/mm² of pressure was applied to the measurement site (in turn, the resin particles present in the measurement site) for 5 minutes using the indenter (load: 100 N) of the jig. Thereafter, the resin particles in the measurement site (specifically, in the hole) were fully collected and left to stand on a mesh (a plain weave sieve with square openings defined in the Japanese Industrial Standards (JIS) Z8801-1, mesh number: 200, wire diameter: 50 μm) with a known mass and an opening of 75 μm. The mass of the sieve including the resin particles was measured to obtain a mass (mass of the resin particles before sucking) of the resin particles on the sieve.

Subsequently, the resin particles on the sieve were sucked from below the sieve using a suction machine (“V-3SDR”, product of AMANO Corporation). The sucking caused only non-blocking resin particles of the resin particles on the sieve to pass through the sieve. After the sucking, the mass (mass of resin particles after the sucking) of resin particles not passed through the sieve (resin particles remaining on the sieve) was measured. A blocking rate (unit: % by mass) of the resin particles was obtained based on the mass of the resin particles before the sucking and the mass of the resin particles after the sucking using the following equation.

Blocking rate=100×mass of resin particles after sucking/mass of resin particles before sucking

TABLE 1

| | Monomer | | | | | Blocking |
|---|---|---|---|---|---|---|
| | BMA | Styrene | DVB | Reaction | Particle | rate |
| | [part by | [part by | [part by | time T | diameter | [% by |
| | mass] | mass] | mass] | [hour] | [nm] | mass] |
| P-1 | 100 | 20 | 35 | 3.0 | 70 | 40 |
| P-2 | 100 | 20 | 50 | 2.0 | 40 | 30 |
| P-3 | 100 | 20 | 70 | 4.0 | 150 | 20 |
| P-4 | 100 | 20 | 20 | 3.0 | 70 | 45 |
| P-5 | 100 | 20 | 85 | 3.0 | 70 | 15 |
| P-6 | 100 | 20 | 50 | 1.5 | 30 | 35 |
| P-7 | 100 | 20 | 70 | 4.5 | 170 | 20 |

### [Toner Mother Particle Preparation]

Using an FM mixier (“FM-10C/I”, product of Nippon Coke & Engineering Co., Ltd.), 100 parts by mass of the polyester resin (binder resin) obtained as above, 4 parts by mass of a colorant (C.I. Pigment Blue 15:3, component: copper phthalocyanine pigment), 1 part by mass of a charge control agent (“BONTRON (registered Japanese trademark) P-51”, product of ORIENT CHEMICAL INDUSTRIES CO., LTD., component: quaternary ammonium salt), and 5 parts by mass of a wax (“NISSAN ELECTOL (registered Japanese trademark) WEP-3”, product of NOF CORPORATION, ester wax with a melting point of 73° C.) as a releasing agent were mixed (dry mixing) at a rotational speed of 2400 rpm.

Subsequently, the resulting mixture was melt-kneaded using a twin screw extruder (“PCM-30”, product of Ikegai Corp.). Thereafter, the resulting melt-kneaded product was cooled. Subsequently, the cooled melt-kneaded product was pulverized using a mechanical pulverizer (“TURBO MILL T250”, product of FREUND-TURBO CORPORATION). Subsequently, the resulting pulverized product was classified using a classifier (“ELBOW JET MODEL EJ-LABO”, product of Nittetsu Mining Co., Ltd.). Thus, a powder of cyan toner mother particles with a volume median diameter (D₅₀) of 6.8 μm was obtained.

Yellow toner mother particles, magenta toner mother particles, and black toner mother particles were prepared according to the same method as that for preparing the cyan toner mother particles in all aspects other than that the colorant was changed to the yellow pigment, the magenta pigment, and the black pigment indicted below, respectively.

Yellow pigment: C.I. Pigment Yellow 74 (“SEIKAFAST (registered Japanese trademark) Yellow 2021” produced by Dainichiseika Color & Chemicals Mfg. Co., Ltd.)

Magenta pigment: C.I. Pigment Red 269 (“PERMANENT CARMINE 3810” produced by SANYO COLOR WORKS, Ltd.).

Black pigment: carbon black (“MITSUBISHI (registered Japanese trademark) CARBON BLACK MA100” produced by Mitsubishi Chemical Corporation)

### [Toner Set Preparation]

By the following methods, toner sets (T-1) to (T-9) were prepared that each included a cyan toner, a magenta toner, a yellow toner, and a black toner.

### (Preparation of Toner Set (T-1))

Using an FM mixer (“FM-10B”, product of Nippon Coke & Engineering Co., Ltd.), 100.0 parts by mass of the aforementioned cyan toner mother particles, 0.6 parts by mass of the resin particles (P-1), and 1.0 part by mass of hydrophobic silica particles (“RA-200H”, product of NIPPON AEROSIL CO., LTD.) were mixed at a stirring speed of 3500 rpm for 5 minutes. As a result, an external additive (the resin particles (P-1) and the hydrophobic silica particles) were attached to the surfaces of the cyan toner mother particles. Thus, a cyan toner (T-1C) was obtained.

A magenta toner (T-1M), a yellow toner (T-1Y), and a black toner (T-1K) were respectively prepared according to the same method as that for preparing the cyan toner (T-1C) in all aspects other than that the magenta toner mother particles, the yellow toner mother particles, and the black toner mother particles were used instead of the cyan toner mother particles. In the following, a combination of the cyan toner (T-1C), the magenta toner (T-1M), the yellow toner (T-1Y), and the black toner (T-1K) is referred to as a toner set (T-1).

### (Preparation of Toner Sets (T-3) to (T-9))

Toner sets (T-2) to (T-9) were prepared according to the same method as that for preparing the toner set (T-1) in all aspects other than that the type and amount used of the resin particles were changed to those shown below in Table 2. In Table 2 below, “Part by mass” under “Resin particles” refers to the part by mass of corresponding resin particles relative to 100 parts by mass of the toner mother particles.

TABLE 2

| | Toner | | | | Resin particles | |
|---|---|---|---|---|---|---|
| Toner set | Cyan | Magenta | Yellow | Black | Type | Part by mas |
| T-1 | T-1C | T-1M | T-1Y | T-1K | P-1 | 0.6 |
| T-2 | T-2C | T-2M | T-2Y | T-2K | P-2 | 0.6 |
| T-3 | T-3C | T-3M | T-3Y | T-3K | P-3 | 0.6 |
| T-4 | T-4C | T-4M | T-4Y | T-4K | P-4 | 0.6 |
| T-5 | T-5C | T-5M | T-5Y | T-5K | P-5 | 0.6 |
| T-6 | T-6C | T-6M | T-6Y | T-6K | P-6 | 0.6 |
| T-7 | T-7C | T-7M | T-7Y | T-7K | P-7 | 0.6 |
| T-8 | T-8C | T-8M | T-8Y | T-8K | P-1 | 0.3 |
| T-9 | T-9C | T-9M | T-9Y | T-9K | P-1 | 1.0 |

### [Carrier Preparation]

Carriers (C-1) to (C-5) were prepared by the following methods. The carriers (C-1) to (C-5) each contained carrier particles each including a carrier core and a coat layer containing a silicone resin. Note that “EF-35B” produced by Powdertech Co., Ltd. was used as the carrier cores. The carrier cores were spherical ferrite cores (number average particle diameter 35 μm, saturation magnetization 68 Am²/kg) containing manganese, magnesium, strontium, and iron.

### (Preparation of Carrier (C-1))

Toluene and a heat-curing type silicone resin (“KR-220L”, product of Shin-Etsu Chemical Co., Ltd., cure start temperature: 170° C.) were mixed to prepare a coating liquid (solid concentration 10% by mass).

Using a fluidized bed coating apparatus (“FD-MP-01 MODEL D”, product of Powrex Corporation), 20 parts by mass of the coating liquid was sprayed to 100 parts by mass of the carrier cores while allowing the carrier cores to flow. Thus, carrier cores coated with the coating liquid were obtained. Conditions for the coating included a feed air temperature of 80° C., feed air flow rate of 0.3 m³/min, and a rotor rotational speed of 400 rpm. Next, the temperature in the fluidized bed of the fluidized bed coating apparatus was increased up to a coating temperature T (330° C. for the carrier (C-1)) shown below in Table 3. The carrier cores coated with the coating liquid were heated at the coating temperature T for 1 hour. Thus, the carrier (C-1) was obtained. The coat layers had a content of 2 parts by mass relative to 100 parts by mass of the carrier (C-1).

### (Preparation of Carriers (C-2) to (C-5))

The carriers (C-2) to (C-5) were prepared according to the same method as that for preparing the carrier (C-1) in all aspects other than that the coating temperature T was changed to those shown below in Table 3. In Table 3 below, the static friction coefficients of the carriers (C-1) to (C-5) are shown in addition.

TABLE 3

| Carrier | Coating temperature T [° C.] | Static friction coefficient |
|---|---|---|
| C-1 | 330 | 0.15 |
| C-2 | 370 | 0.10 |
| C-3 | 280 | 0.20 |
| C-4 | 400 | 0.09 |
| C-5 | 250 | 0.25 |

### <Two-component Developer Set Preparation>

According to the combinations shown below in Table 4, 6 parts by mass of a toner (specifically, any of the toners (T-1C) to (T-9K) included in any of the toner set (T-1) to (T-9K)) and 100 parts by mass of a carrier (specifically, any of the carriers (C-1) to (C-5)) were mixed for 30 minutes using a rocking mixer (“TURBULA (registered Japanese trademark) MIXER T2F”, product of Willy A. Bachofen AG (WAB)). Thus, two-component developer sets of Examples 1 to 7 and Comparative Examples 1 to 6 were obtained. Each of the two-component developer sets included a cyan developer, a magenta developer, a yellow developer, and a black developer.

TABLE 4

| | Toner set | | | | | |
|---|---|---|---|---|---|---|
| | | Toner | | | | |
| | | | | Yel- | | Car- |
| Developer set | Type | Cyan | Magenta | low | Black | rier |
| Example 1 | T-1 | T-1C | T-1M | T-1Y | T-1K | C-1 |
| Example 2 | T-2 | T-2C | T-2M | T-2Y | T-2K | C-1 |
| Example 3 | T-3 | T-3C | T-3M | T-3Y | T-3K | C-1 |
| Example 4 | T-1 | T-1C | T-1M | T-1Y | T-1K | C-2 |
| Example 5 | T-1 | T-1C | T-1M | T-1Y | T-1K | C-3 |
| Example 6 | T-8 | T-8C | T-8M | T-8Y | T-8K | C-1 |
| Example 7 | T-9 | T-9C | T-9M | T-9Y | T-9K | C-1 |
| Comparative Example 1 | T-4 | T-4C | T-4M | T-4Y | T-4K | C-1 |
| Comparative Example 2 | T-5 | T-5C | T-5M | T-5Y | T-5K | C-1 |
| Comparative Example 3 | T-6 | T-6C | T-6M | T-6Y | T-6K | C-1 |
| Comparative Example 4 | T-7 | T-7C | T-7M | T-7Y | T-7K | C-1 |
| Comparative Example 5 | T-1 | T-1C | T-1M | T-1Y | T-1K | C-4 |
| Comparative Example 6 | T-1 | T-1C | T-1M | T-1Y | T-1K | C-5 |

### <Evaluation>

Image density and fog of images formed in a normal-temperature and normal-humidity environment or a high-temperature and high-humidity environment were evaluated by the following methods for the two-component developer sets of Examples 1 to 7 and Comparative Examples 1 to 6. The evaluation results are shown below in Table 5.

### [Evaluation Apparatus]

A color printer (“ECOSYS (registered Japanese trademark) P6230cdn”, product of KYOCERA Document Solutions Japan Inc.) with an organic photoconductor mounted therein was modified to adopt the two-component development system and change the system linear velocity to 270 mm/sec. The resulting apparatus was used as an evaluation apparatus. The two-component developers (specifically, the cyan developer, the magenta developer, the yellow developer, and the black developer) included in a two-component developer set (any of the two-component developer sets of Examples 1 to 7 and Comparative Examples 1 to 6) being an evaluation target were respectively loaded into the development device for cyan color, the development device for magenta color, the development device for yellow color, and the development device for black color of the evaluation apparatus. Also, the corresponding toners (specifically, the same toners as the toners of the two-component developers included in the two-component developer set being the evaluation target) were respectively loaded into a cyan toner container, a magenta toner container, a yellow toner container, and a black toner container of the evaluation apparatus.

### [Recording Medium]

As a recording medium, “C²” produced by FUJIFILM Business Innovation Japan Corp. was used.

### [Normal-temperature and Normal-humidity Environment]

A pattern image (printing rate 5%) with four colors of cyan, magenta, yellow, and black was consecutively formed on 200,000 sheets of the recording medium in a normal-temperature and normal-humidity environment (23° C., 50% RH). Next, an evaluation image (NN) including a cyan solid image, a magenta solid image, a yellow solid image, a black solid image, and a blank part (non-printed part) was formed on one sheet of the recording medium.

### (Image Density)

Using a fluorescence spectrodensitometer (“FD-7”, product of KONICA MINOLTA JAPAN, INC.), an image density (ID_{C}) of the cyan solid image, an image density (ID_{M}) of the magenta solid image, an image density (ID_{Y}) of the yellow solid image, and an image density (ID_{K}) of the black solid image were measured in the evaluation image (NN). The minimum value of ID_{C}, ID_{M}, ID_{Y}, and ID_{K} was used as an evaluation value (ID) for image density. Image density was evaluated according to the following criteria.

### (Criteria of Image Density)

A (particularly good): ID of at least 1.250
B (good): ID of at least 1.000 and less than 1.250
C (poor): ID of less than 1.000

### (Fogging)

Using the aforementioned reflectance densitometer, an image density (ID_{A}) of the blank part (fog of 4 colors in total of cyan, magenta, yellow, and black) of the evaluation image (NN) and an image density (ID_{B}: background value) of an unused sheet of the recording medium were measured. A value calculated using an equation “FD=ID_{A}−ID_{B}” was used as an evaluation value (FD) for fogging. Fogging was evaluated according to the following criteria.

### (Criteria of Fogging)

A (particularly good): FD of no greater than 0.003
B (good): FD of greater than 0.003 and no greater than 0.010
C (poor): FD of greater than 0.010

### [High-Temperature and High-Humidity Environment]

A pattern image (printing rate 1%) with four colors of cyan, magenta, yellow, and black was consecutively formed on 100,000 sheets of the recording medium in a high-temperature and high-humidity environment (32.5° C., 80% RH). Next, an evaluation image (HH) including a cyan solid image, a magenta solid image, a yellow solid image, a black solid image, and a blank part (non-printed part) was formed on one sheet of the recording medium. Image density and fogging in the high-temperature and high-humidity environment were evaluated for the evaluation target according to the same method as the evaluation in the normal-temperature and normal-humidity environment in all aspects other than that the evaluation image (HH) was used instead of the evaluation image (NN).

TABLE 5

| | | | In normal-temperature and | | | | In high-temperature and | | | |
|---|---|---|---|---|---|---|---|---|---|---|
| | | | normal-humidity environment | | | | high-humidity environment | | | |
| | | | Image density | | Fogging | | Image density | | Fogging | |
| Developer set | Toner set | Carrier | ID | Rating | FD | Rating | ID | Rating | FD | Rating |
| Example 1 | T-1 | C-1 | 1.305 | A | 0.003 | A | 1.160 | B | 0.003 | A |
| Example 2 | T-2 | C-1 | 1.255 | A | 0.003 | A | 1.050 | B | 0.003 | A |
| Example 3 | T-3 | C-1 | 1.285 | A | 0.007 | B | 1.145 | B | 0.003 | A |
| Example 4 | T-1 | C-2 | 1.320 | A | 0.005 | B | 1.220 | B | 0.007 | B |
| Example 5 | T-1 | C-3 | 1.310 | A | 0.007 | B | 1.115 | B | 0.004 | B |
| Example 6 | T-8 | C-1 | 1.300 | A | 0.003 | A | 1.130 | B | 0.003 | A |
| Example 7 | T-9 | C-1 | 1.320 | A | 0.005 | B | 1.205 | B | 0.004 | B |
| Comparative Example 1 | T-4 | C-1 | 1.305 | A | 0.003 | A | 0.980 | C | 0.003 | A |
| Comparative Example 2 | T-5 | C-1 | 1.330 | A | 0.012 | C | 1.302 | A | 0.004 | B |
| Comparative Example 3 | T-6 | C-1 | 1.250 | A | 0.003 | A | 0.985 | C | 0.003 | A |
| Comparative Example 4 | T-7 | C-1 | 1.250 | A | 0.011 | C | 0.990 | C | 0.005 | B |
| Comparative Example 5 | T-1 | C-4 | 1.335 | A | 0.009 | B | 1.245 | B | 0.012 | C |
| Comparative Example 6 | T-1 | C-5 | 1.300 | A | 0.012 | C | 1.150 | B | 0.005 | B |

As shown in Tables 1 to 5, each of the two-component developers included in any of the two-component developer sets of Examples 1 to 7 included a carrier containing carrier particles and a toner containing toner particles. The carrier particles each included a carrier core and a coat layer covering the surface of the carrier core. The coat layers contained a silicone resin. The carrier particles had surfaces with a static friction coefficient of at least 0.10 and no greater than 0.22. The toner particles each included a toner mother particle and an external additive attached to the surface of the toner mother particle. The external additive included resin particles. The resin particles had a number average primary particle diameter of at least 35 nm and no greater than 160 nm. The resin particles had a blocking rate of at least 17% by mass and no greater than 42% by mass, as measured using a mesh sieve with an opening of 75 μm after 5-minite pressure application at a temperature of 160° C. and a pressure of 0.1 kgf/mm². Each of the two-component developers included in the two-component developer sets of Examples 1 to 7 formed images with desired image density and inhibited occurrence of fogging regardless of the environment.

By contrast, the blocking rates of the resin particles were excessively high in the two-component developer set of Comparative Example 1. Resin particles with an excessively high blocking rate are determined to insufficiently exhibit their spacer function due to being too soft. As a result, the two-component developer set of Comparative Example 1 did not form images with desired image density in the high-temperature and high-humidity environment.

The blocking rates of the resin particles were excessively low in the two-component developer set of Comparative Example 2. Resin particles with an excessively low blocking rate are determined to tend to polish a photosensitive member (particularly, an organic photoconductor) due to being too hard. As a result, the two-component developer set of Comparative Example 2 did not inhibit occurrence of fogging in the normal-temperature and normal-humidity environment.

The number average primary particle diameters of the resin particles were excessively small in the two-component developer set of Comparative Example 3. Resin particles with an excessively small number average primary particle diameter are determined to insufficiently exhibit their spacer function. As a result, the two-component developer set of Comparative Example 3 did not form images with desired image density in the high-temperature and high-humidity environment.

The number average primary particle diameters of the resin particles were excessively large in the two-component developer set of Comparative Example 4. Resin particles with an excessively large number average primary particle diameter are determined to tend to separate from toner mother particles as a result of image formation. As a result, the two-component developer set of Comparative Example 4 did not form images with desired image density in the high-temperature and high-humidity environment. Also, the two-component developer set of Comparative Example 4 did not inhibit occurrence of fogging in the normal-temperature and normal-humidity environment.

The surfaces of the carrier particles in the two-component developer set of Comparative Example 5 had an excessively small static friction coefficient. Carrier particles having surfaces with an excessively small static friction coefficient are determined to be incapable of triboelectrically charging toner particles sufficiently. As a result, the two-component developer set of Comparative Example 5 did not inhibit occurrence of fogging in the high-temperature and high-humidity environment.

The surfaces of the carrier particles in the two-component developer set of Comparative Example 6 had excessively large static friction coefficients. Carrier particles having surfaces with an excessively large static friction coefficient are determined to tend to polish a photosensitive member (particularly, an organic photoconductor). As a result, the two-component developer set of Comparative Example 6 did not inhibit occurrence of fogging in the normal-temperature and normal-humidity environment.

What is claimed is:

1. A two-component developer comprising:
a carrier containing carrier particles; and
a toner containing toner particles, wherein
the carrier particles each include a carrier core and a coat layer covering a surface of the carrier core,
the coat layers contain a silicone resin,
the carrier particles have surfaces with a static friction coefficient of at least 0.10 and no greater than 0.22,
the toner particles each include a toner mother particle and an external additive attached to a surface of the toner mother particle,
the external additive includes resin particles,
the resin particles have a number average primary particle diameter of at least 35 nm and no greater than 160 nm, and
the resin particles have a blocking rate of at least 17% by mass and no greater than 42% by mass, as measured using a mesh sieve with an opening of 75 μm after 5-minite pressure application at a temperature of 160° C. and a pressure of 0.1 kgf/mm².

2. The two-component developer according to claim 1, wherein
the resin particles contain styrene-(meth)acrylic resin,
the styrene-(meth)acrylic resin includes a first repeating unit derived from a styrene compound, a second repeating unit derived from a (meth)acrylic acid alkyl ester, and a third repeating unit derived from a crosslinking agent, and
the third repeating unit has a percentage content of at least 20.0% by mass and no greater than 40.0% by mass to all repeating unites included in the styrene-(meth)acrylic resin.

3. The two-component developer according to claim 2, wherein
the crosslinking agent includes divinylbenzene.

4. The two-component developer according to claim 1, wherein
the resin particles have a content of at least 0.1 parts by mass and no greater than 5.0 parts by mass relative to 100 parts by mass of the toner mother particles in the toner particles.

5. An image forming apparatus comprising:
the two-component developer according to claim 1;
an image bearing member;
a charger that charges a surface of the image bearing member;
a light exposure device that exposes the charged surface of the image bearing member to light to form an electrostatic latent image on the surface of the image bearing member; and
a development device that develops the electrostatic latent image into a toner image by supplying the toner to the surface of the image bearing member, wherein the image bearing member is an organic photoconductor.

6. The image forming apparatus according to claim 5, wherein
the image forming apparatus is set to have a system linear velocity of at least 250 mm/sec and no greater than 500 mm/sec.
